(19) United States
(12) Patent Application Publication
(10) Pub. No.: US 2004/0066597 A1
(43) Pub. Date: Apr. 8, 2004

(54) Telemetry shield diffuser

(76) Inventor: Francis R. Losey, Boca Raton, FL (US)

Correspondence Address: ROBERT M. DOWNEY, P.A., ATTORNEYS FOR APPLICANT, 601 SOUTH FEDERAL HIGHWAY, SUITE 300, BOCA RATON, FL, 33432, US

(21) Appl. No.: 10/263,567

(22) Filed: Oct. 2, 2002

(51) Int. Cl. H02H 1/00

(52) U.S. Cl. 361/118

(57) ABSTRACT

A diffuser provides a conductive path to ground for potentially damaging dielectric energy carried on the protective shield conductor of a telemetry cable, and acts to protect the cable's signal-carrying conductors, as well as connected devices, from potentially damaging dielectric buildup. The diffuser includes a circuit with one or more suppression elements. The suppression element(s) is normally in a high impedance state. When transient voltages and/or currents are present (e.g. as a result of lightning), and dielectric energy is carried on the shield conductor, the suppression element(s) rapidly switches to a low impedance state, and a dissipating or diffusing path is created to divert the incoming energy to ground. When the transient is gone, the circuit returns to the idle, high impedance state. The circuit may further include a protective element connected in series with the suppression element. The protective element acts as a fuse to interrupt the circuit permanently in the event a transient exceeds the thermal rating of the device.

### BACKGROUND OF THE INVENTION

1. Field of the Invention

The invention relates to a device for diffusing dielectric energy buildup and, more particularly, to a diffuser device for providing a path to ground for dielectric energy carried on the protective shield conductor of a telemetry cable.

2. Discussion of the Related Art

Modern day industrial, commercial and utility systems have become quite sophisticated. Many of these systems utilize sensors, transducers, and microprocessor-controlled devices to gather signals and information used in the command, control, and supervision of critical processes. Telemetry cables are used to interconnect the components of these sophisticated systems and act as data highways for carrying information between the components. Examples of telemetry cables include communication lines, such as parallel or serial, utilizing RS-232, RS-422, or RS-485 and are often used in connecting signal processing devices, such as programmable logic controllers (PLC's) and intelligent electronic devices (IED's), to sensors and/or transducers. Examples of sensors and transducers commonly found in such systems include current loops, voltage transducers, temperature sensors, humidity sensors, airflow sensors, load cells and moisture probes.

With increasing dependence on analog and microprocessor-based devices, as well as reduced maintenance resources and demands for greater up-time, there is a growing need for implementing a comprehensive surge protection program throughout a facility in order to prevent surges from damaging the components of the facility's systems. While most surge protection programs cover utility service entrance, point-of-use, and signal line protection, they do not address the electrical impulses carried by the shield conductor of a telemetry cable used to transmit signals to and from system components.

In a typical industrial system, as addressed above, the telemetry cable which carries data signals between sensors or transducers and a central processing unit is a multiple conductor cable, wrapped with a conductive shield, and covered with an insulating sleeve. The purpose of the shield conductor is to protect the integrity of data signals from radio frequency interference (RFI) or electrical magnetic interference (EMI). The shield conductor is typically connected to ground only at the point where the central processing unit is located. The opposite end of the cable, connected to a device such as a sensor to transducer, is intentionally left unterminated or “floating” in order to prevent ground currents from circulating between differential ground points, thereby preventing interference with the signals coming from the sensors/transducers which might otherwise result in inaccurate and unreliable operation.

When surge currents are carried through a facility's grounding system, such as during an electrical storm, small amounts of grounding resistance can induce very large voltage impulses. These impulses can be carried on the shield conductor of the telemetry cables and to the system components connected to the telemetry cables. Damage to the system components can occur when these significant voltage impulses either “punch through” the insulation separating the data-carrying conductors and the shield conductor, or are coupled by mutual inductance on the signal conductors of the telemetry cable, thereby enabling the transient voltage impulses to make their way into the connected components (e.g. sensors, transducers, load cells, etc.). When this happens, the connected component is usually damaged, requiring costly maintenance and repair, and, most significantly, incurring unrecoverable lost production time.

In view of the foregoing, there remains an urgent need for a diffuser device for use in an electrical distribution shielding program for protecting the signal carrying conductors inside of a telemetry cable, as well as the devices connected thereto, from damaging dielectric energy buildup by providing a path to ground for energy carried on the telemetry cable's protective shield conductor.

### SUMMARY OF THE INVENTION

The telemetry shield diffuser device of the present invention is specifically designed to diffuse a transient's dielectric energy buildup from the telemetry cable's shield conductor by providing a conductive path to ground thereby protecting the telemetry cable's signal carrying conductors, as well as devices connected thereto, from potentially damaging dielectric energy buildup. The telemetry shield diffuser device includes a circuit which, in one preferred embodiment, may be encapsulated within a non-conductive housing. The circuit includes one or more suppression elements and a protective element connected in series. In normal operation, the device sits idle, in a high-impedance state, thereby preventing unwanted potential ground loop interference which can result when two separate ground planes are connected together. When transient voltage and/or currents are present (e.g. as a result of lightning), and dielectric energy is carried on the shield conductor, the suppression element(s) rapidly switches to a low impedance state. This creates a diffusing path for diverting the dielectric energy to ground. When the transient energy is gone, the circuit returns to the idle, high impedance state. The protective element is inserted in series with the suppression element(s) and acts to interrupt the circuit permanently should a high current situation arise during a transient event. In a preferred embodiment, the protective element is a transient tolerant fuse having characteristics designed to withstand industry defined transient levels.

### OBJECTS AND ADVANTAGES OF THE INVENTION

With the foregoing in mind, it is a primary object of the present invention to provide a device for providing a conductive path to ground for electric energy carried on a protective shield conductor of a telemetry cable, thereby preventing potentially damaging dielectric energy buildup.

It is a further object of the present invention to provide a device which enhances the protection of the signal carrying conductors inside of a telemetry cable, as well as the end devices connected to the telemetry cable, from damaging dielectric energy buildup by providing a path to ground for energy carried on a telemetry cable's protective shield conductor.

It is still a further object of the present invention to provide a telemetry shield diffuser device which, in normal operation, remains idle (i.e. essentially out of circuit) in a high impedance state, thereby preventing unwanted ground currents from circulating and interfering with the telemetry signals.

It is still a further object of the present invention to provide a telemetry shield diffuser device which rapidly switches from a high impedance state to a low impedance state when dielectric energy buildup occurs, thereby providing an extremely fast conductive path for diffusing the dielectric energy to ground.

It is still a further object of the present invention to provide a relatively inexpensive device for protecting signal carrying conductors of a telemetry cable, as well as the devices connected to the telemetry cable, from damage resulting from dielectric energy buildup on the protective shield conductor of the telemetry cable.

It is still a further object of the present invention to provide a relatively inexpensive device which significantly reduces the likelihood of costly interruptions of a commercial or industrial process (i.e. downtime) due to damage resulting from dielectric energy buildup on the protective shield conductor of telemetry cables.

It is still a further object of the present invention to provide a relatively inexpensive diffuser device which prevents costly maintenance, repair and/or replacement of equipment damaged as a result of dielectric energy buildup on the shield conductor of telemetry cables.

It is still a further object of the present invention to provide a relatively inexpensive dielectric energy diffuser device which significantly reduces lost production time in industrial, commercial and utility system operations.

These and other objects and advantages of the present invention are more readily apparent with reference to the following detailed description and accompanying drawings:

### BRIEF DESCRIPTION OF THE DRAWINGS

For a fuller understanding of the nature of the present invention, reference should be made to the following detailed description taken in conjunction with the accompanying drawings in which:

FIG. 1 is a general schematic illustrating a typical shield grounding practice in the prior art wherein the shield conductor of a telemetry cable connecting between a signal processing device and a sensor, transducer or other electronic device is connected to ground at both ends;

FIG. 2 is a general schematic illustrating another typical shield grounding practice in the prior art wherein the shield conductor of a telemetry cable connecting between a signal processing device, sensor, transducer or other electronic device is connected to ground at one end while the opposite end remains unconnected or floating;

FIG. 3 is a general schematic illustrating the telemetry shield diffuser device of the present invention installed between the shield conductor of the telemetry cable and a remote ground, in accordance with one preferred embodiment thereof;

FIG. 4 is a schematic diagram of the telemetry shield diffuser device of the present invention, illustrating the principle components thereof;

FIG. 5 is an isolated perspective view illustrating connection of the telemetry cable shield conductor and a ground wire to the diffuser device of the present invention; and

FIG. 6 is a general diagram of a telemetry shield grounding system of a typical industrial mixing plant using a load cell transducer for measuring a critical mixing process, and wherein connection of the telemetry shield diffuser device of the present invention is shown in broken lines to illustrate a typical example of use of the invention in an existing system.

Like reference numerals refer to like parts throughout the several views of the drawings.

### DETAILED DESCRIPTION OF THE PREFERRED EMBODIMENTS

The present invention is directed to a telemetry shield diffuser for protecting signal carrying conductors inside of a telemetry cable, as well as devices connected to the telemetry cable, and is generally indicated throughout the several drawing figures.

The telemetry shield diffuser 10 is particularly useful in applications wherein digital and analog information is transmitted between a signal processing device and any of various electronic measuring devices such as sensors and transducers. More specifically, the telemetry shield diffuser 10 provides a path to ground for energy carried on the protective shield conductor 34 of telemetry cables 30 interconnecting the signal processing device and the electronic measuring devices.

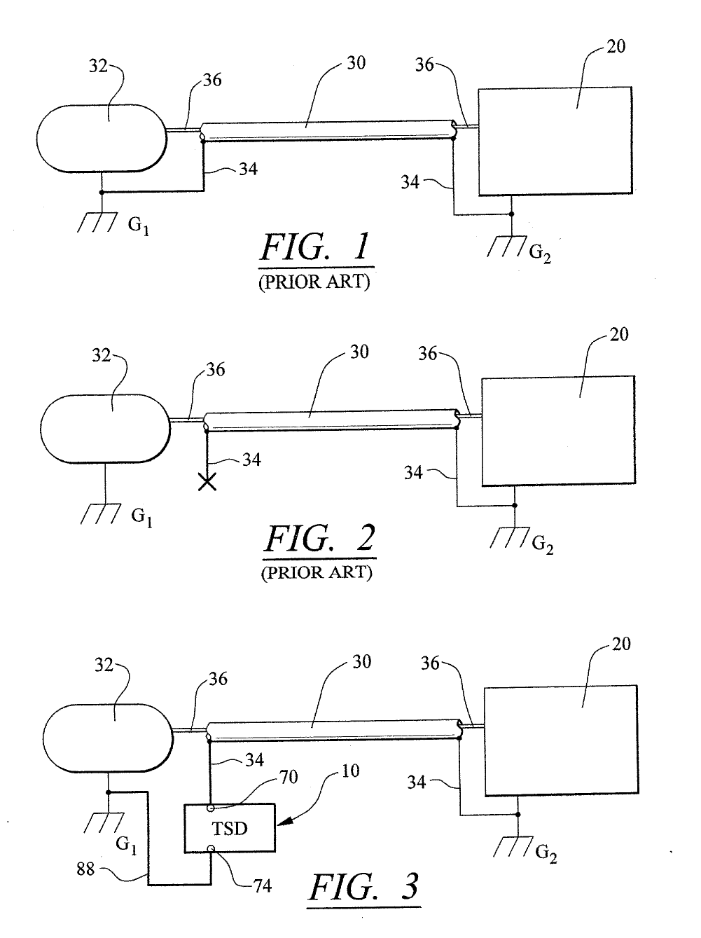

Several examples of shielding practices presently used in the prior art are shown in FIGS. 1 and 2. Specifically, FIG. 1 shows a prior art example of a shielding practice used where a telemetry cable 30 is interconnected between a signal processing device 20 and a sensor, transducer, or other electronic device 32. The telemetry cable 30 is used to carry numerous data via signal conductors 36 to and from the end devices 32. The shield conductor 34 is used to protect the internal conductors 36 from Radio Frequency Interference (RFI) and Electromagnetic Interference (EMI). In FIG. 1, the shield conductor 34 is connected to ground connections G1 and G2 at each end of the telemetry cable. This particular shield conductor grounding method presents the problem of electric ground currents circulating from one grounding point to another through the shield conductor of the telemetry cable during normal operation. These ground currents can cause interference in data or signal transmission, thereby affecting the operating process (e.g. mixing, batching, etc.).

In FIG. 2, another prior art example of a shielding practice is shown, wherein the telemetry cable 30 is again connected between a signal processing device 20 and a sensor, transducer or other electronic device 32. This example shows the predominant practice used in the field, whereby the shield conductor 34 is connected to ground at one end G2, typically where the intelligent device (e.g. signal processing device) is located. Unlike the example in FIG. 1, this methodology of grounding the shield conductor 34 does prevent ground currents from circulating during normal operation. This is achieved by leaving the shield conductor 34 disconnected or “floating” at one end. However, when transient currents are present, a significant problem can occur with use of this particular grounding method. Specifically, transient currents from events such as lightning can generate significant and damaging voltage potentials which can punch through insulation or be inductively coupled into the devices at either end of the cable, causing damage.

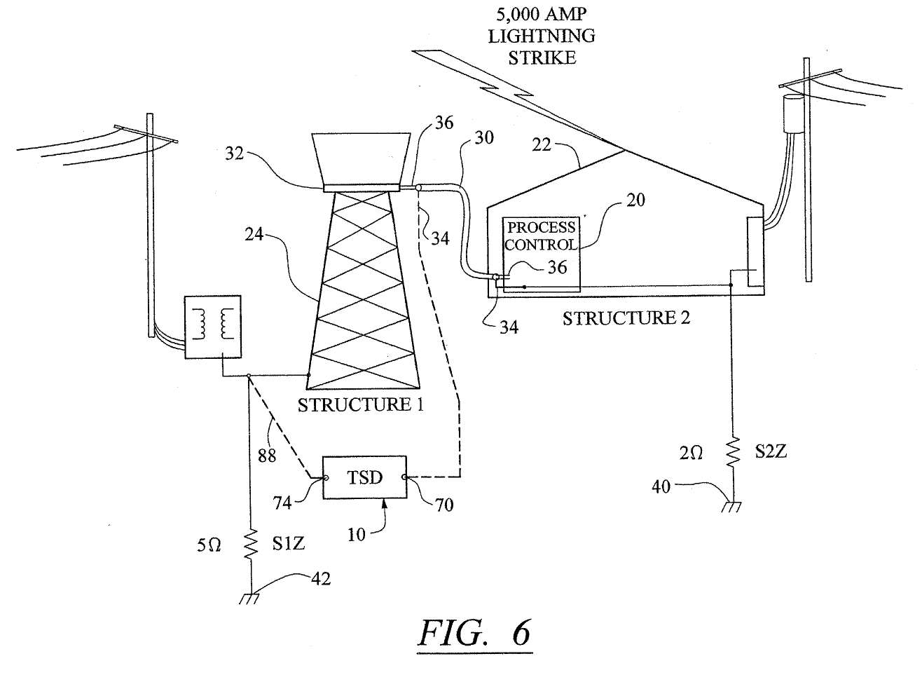

FIG. 6 further illustrates this problem wherein one end of the shield conductor 34 is left floating. Referring to FIG. 6, a typical example of an industrial process facility is illustrated wherein a signal processing device 20 (i.e. a process control computer), located in a building 22 is used for controlling a process at remote structure 24. A telemetry cable 30 connects the signal processing device 20 to a transducer, sensor or other electronic device at the structure 24. The transducer/sensor 32 senses and/or measures a particular activity in the controlled process taking place at structure 24. The telemetry cable 30 serves as a data highway, allowing information to be exchanged between the signal processing device 20 and the transducer/sensor 32. The shield conductor 34 of the telemetry cable 30 is connected to the ground point 40 of the building which, in this example has an impedance of two Ohms. The remote structure 24 is grounded at ground point 42 which has an impedance of five Ohms. If a lightening strike of 5,000 Amps were to strike the building 22, or near the building 22, a transient current will seek to find its way back to earth through the electrical system ground. In a simplified illustration, when a transient is carried through the grounding points 40, 42 shown in FIG. 5, the following voltages are developed across these impedances:

| | |
|---|---|
| Ground point 40: E = I × R | Ground point 42: E + I × R |
| E = 5,000 Amps × 2 Ohms = 10,000 | E = 5,000 Amps × 5 Ohms = |
| Volts | 25,000 Volts |

According to the above example, a voltage induced at the two system grounding points 40, 42 created a potential difference of 15,000 Volts. Under these circumstances, dielectric energy can easily cause damage to system components.

Referring now to FIG. 3, the telemetry shield diffuser device 10 of the present invention is shown installed in a typical application as described in connection with FIGS. 1 and 2. Specifically, the telemetry shield diffuser device 10 is connected to one end of the shield conductor 34 of the telemetry cable 30 with the use of a terminal lug 80, a screw 82 and a lock washer 84, as shown in FIG. 5. As shown in FIG. 3, the telemetry shield diffuser device 10 is installed between the shield conductor of the telemetry cable and the remote ground G1 in the vicinity of the sensor, transducer or other electronic device 32. Unlike the example of FIG. 1, the telemetry shield diffuser device 10 prevents ground currents from circulating during normal operation. Moreover, unlike the example of FIG. 2, the telemetry shield diffuser device 10 provides a diffusion path for any transient dielectric buildup, thereby protecting the signal carrying conductors inside of the telemetry cable, as well as the end connected devices, from damage.

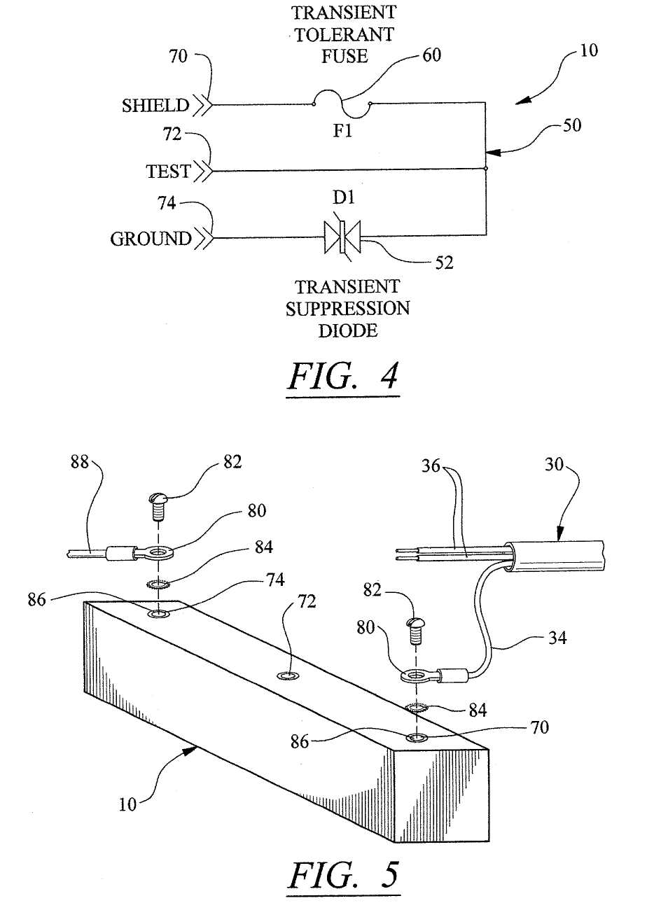

Referring to FIG. 4, the primary components of the telemetry shield diffuser device 10 are shown in schematic form. The device 10 essentially has two operational sections, namely a suppression section and a protection section. The suppression section is comprised of one or more components which are particularly adapted for use in conjunction with the protection section. A circuit 50 includes the one or more suppression elements 52 connected in series with the one or more protection elements 60. In a preferred embodiment, the suppression section of the device 10 includes a Transient Voltage Suppression diode (TVS diode) 52 and can be accompanied by secondary protective elements such as gas discharge tubes, Metal Oxide Varistors (MOV's) or other surge protective components. In normal operation, when no transient is present, the suppression component 52 is in a high impedance state and essentially out of circuit. When a transient enters the system, the device switches extremely fast from a high impedance state to a low impedance state, providing a dissipating or diffusing path for the incoming energy to be diverted to ground. When the transient is no longer present, the circuit returns to the idle, high impedance state.

The protective element 60 of the device 10 is inserted in series with the suppression element(s) 52 and acts to interrupt the circuit permanently should a surge current exceed the thermal power rating of the device during a transient event. In a preferred embodiment, the protective element 60 of the protective section is a transient tolerant fuse 60 having characteristics designed to withstand industry defined transient voltages.

The components of the telemetry shield diffuser device 10, as seen in FIG. 4, may be encapsulated within a non-conductive housing. In a preferred embodiment, the components are encapsulated within a non-conductive epoxy to protectively embed the internal components in a self-contained package. The connections of the telemetry shield diffuser device 10 are labeled in FIGS. 4 and 5 as the shield 70, test 72, and ground 74. The shield connection 70 connects to the telemetry cable's shield conductor(s). To accomplish this, a mechanical connection is employed with the use of a ring terminal lug 80 and a female standoff 86 is embedded in the non-conductive epoxy body of the device 10. A screw 82 and lock washer 84 secure terminal lug 80 to the respective female standoff 86, as shown in FIG. 5. A separate ground wire 88 connects to ground connection 74 with a similar terminal lug 80, screw 82 and lock washer 84 and is typically bonded to the local system “earth” ground. This wire provides the path for energy to be carried to ground. The test connection point 72 is typically left unconnected and is used in the field to allow connection of test equipment in order to determine whether the device 10 is working properly.

While the present invention has been shown and described in accordance with a preferred and practical embodiment thereof, it is recognized that departures from the instant disclosure are contemplated within the spirit and scope of the invention as set forth in the following claims and under the doctrine of equivalents.

What is claimed is:

1. A device for attachment to a protective shield conductor of a telemetry cable for providing a conductive path to ground for electric energy carried on the protective shield conductor, said device comprising:
a circuit including at least one suppression element;
means for connecting a ground conductor to said circuit; and
said at least one suppression element being in a normally high impedance state and being structured and disposed to switch to a low impedance state when electric energy is carried on the protective shield conductor to create a diffusing path that diverts the electric energy to ground, and said at least one suppression element being structured to return to the normally high impedance state when the electric energy is released from the protective shield conductor.

2. The device as recited in claim 1 wherein said at least one suppression element comprises a transient voltage suppression diode.

3. The device as recited in claim 1 comprising a plurality of said suppression elements.

4. The device as recited in claim 3 wherein one of said plurality of suppression elements is a voltage suppression diode.

5. The device as recited in claim 3 wherein one of said plurality of suppression elements is a gas discharge tube.

6. The device as recited in claim 3 wherein one of said plurality of suppression elements is a metal oxide varistor.

7. The device as recited in claim 3 wherein one of said plurality of suppression elements is a surge protective element.

8. The device as recited in claim 1 wherein said circuit further includes a protective element structured and disposed to interrupt the circuit when electric energy carried on the protective shield conductor exceeds the thermal power capacity of the device.

9. The device as recited in claim 8 wherein said protective element is a fuse.

10. The device as recited in claim 9 wherein said fuse is a transient tolerant fuse.

11. The device as recited in claim 1 further comprising a housing encapsulating said circuit.

12. The device as recited in claim 11 wherein said housing is formed of a non-conductive epoxy.

13. A device for attachment to a protective shield conductor of a telemetry cable for providing a conductive path to ground for electric energy carried on the protective shield conductor, said device comprising:
a circuit including at least one suppression element and at least one protective element connected in series;
means for connecting a ground conductor to said circuit;
said at least one suppression element being in a normally high impedance state and being structured and disposed to switch to a low impedance state when electric energy is carried on the protective shield conductor to create a diffusing path that diverts the electric energy to ground, and said at least one suppression element being structured to return to the normally high impedance state when the electric energy is released from the protective shield conductor; and
said at least one protective element being structured and disposed to interrupt the circuit when electric energy carried on the protective shield conductor exceeds the thermal power capacity of the device.

14. The device as recited in claim 13 wherein said at least one suppression element comprises a voltage suppression diode.

15. The device as recited in claim 13 comprising a plurality of said suppression elements.

16. The device as recited in claim 15 wherein one of said plurality of suppression elements is a transient voltage suppression diode.

17. The device as recited in claim 16 wherein one of said plurality of suppression elements is a gas discharge tube.

18. The device as recited in claim 16 wherein one of said plurality of suppression elements is a metal oxide varistor.

19. The device as recited in claim 16 wherein one of said plurality of suppression elements is a surge protective element.

20. A device for attachment to a protective shield conductor of a telemetry cable for providing a conductive path to ground for electric energy carried on the protective shield conductor, said device comprising:
a circuit including at least one suppression element and at least one protective element connected in series;
means for connecting a ground conductor to said circuit;
a housing encapsulating said circuit;
said at least one suppression element being in a normally high impedance state and being structured and disposed to switch to a low impedance state when electric energy is carried on the protective shield conductor to create a diffusing path that diverts the electric energy to ground, and said at least one suppression element being structured to return to the normally high impedance state when the electric energy is released from the protective shield conductor; and
said at least one protective element being structured and disposed to interrupt the circuit when electric energy carried on the protective shield conductor exceeds the thermal power capacity of the device.
